(19) United States
(12) Patent Application Publication
(10) Pub. No.: US 2018/0253737 A1
(43) Pub. Date: Sep. 6, 2018

(54) Dynamicall Evaluating Fraud Risk

(71) Applicant: International Business Machines Corporation, Armonk, NY (US)

(72) Inventors: Thomas T. Hanis, Raleigh, NC (US); Eugene I. Kelton, Mechanicsburg, PA (US); Yi-Hui Ma, Mechanicsburg, PA (US); Willie R. Patten, JR., Hurdle Mills, NC (US)

(21) Appl. No.: 15/450,966

(22) Filed: Mar. 6, 2017

(51) Int. Cl. G06Q 30/00; G06F 17/50; G06N 99/00

(52) U.S. Cl. CPC G06Q 30/0185; G06F 2217/16; G06N 99/005; G06F 17/5009

(57) ABSTRACT

A mechanism is provided for dynamically evaluating fraud risk. Responsive to receiving a notification, a set of indicators associated with a focal object are automatically analyzed to form a combined assessment. The combined assessment is compared to a set of pattern fraud determinations. The combined assessment is then adjusted based on the set of pattern fraud determinations to dynamically determine a current fraud assessment of the focal object. An action is them performed based on the current fraud assessment.

### BACKGROUND

The present application relates generally to an improved data processing apparatus and method and more specifically to mechanisms for dynamically evaluating fraud risk.

Fraud is deliberate deception to secure unfair or unlawful gain, or to deprive a victim of a legal right. Fraud itself can be a civil wrong (i.e., a fraud victim may sue the fraud perpetrator to avoid the fraud and/or recover monetary compensation), a criminal wrong (i.e., a fraud perpetrator may be prosecuted and imprisoned by governmental authorities), or may cause no loss of money, property, or legal right but still be an element of another civil or criminal wrong.

If fraud is perpetrated in an enterprise, the enterprise may lose a significant amount of assets. At an extreme level, the effects of fraud may even shut down the enterprise. There are a number of factors that make it more likely that fraud will occur or is occurring in an enterprise. These fraud risk factors include:
Nature of Items, e.g. size, value, or the like;
Nature of Control Environment—e.g. separation of duties, safeguards, documentation, related party transactions, complexity, or the like; and
Pressures—level of dissatisfaction, expectations, guarantees, or the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for dynamically evaluating fraud risk. The illustrative embodiment automatically analyzes a set of indicators associated with a focal object to form a combined assessment in responsive to receiving a notification. The illustrative embodiment compares the combined assessment to a set of pattern fraud determinations. The illustrative embodiment adjusts the combined assessment based on the set of pattern fraud determinations to dynamically determine a current fraud assessment of the focal object. The illustrative embodiment then performs an action based on the current fraud assessment.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts an exemplary functional block diagram of a data processing system in which a dynamic fraud risk evaluation mechanism operates in accordance with an illustrative embodiment;

FIG. 4 depicts one example of an aggregation of profile elements when assessed by the dynamic fraud risk evaluation mechanism 302 of FIG. 3 in accordance within an illustrative embodiment; and

FIG. 5 depicts an exemplary flow diagram of the operation performed by a dynamic fraud risk evaluation mechanism in accordance with an illustrative embodiment.

### DETAILED DESCRIPTION

The illustrative embodiments provide mechanisms for dynamically evaluating fraud risk. Determining fraud risk is a multi-step process, generally involving some type of scoring based analysis followed by a determination of a risk category that the scoring relates to. The scoring may involve computational models, statistical analysis, deterministic rules, or other techniques to arrive at a numerical score. This score may even be an aggregation or sum of many individual (smaller scoped) scores. The risk categorization, such as high, medium, low, or the like, may be based on this score and the context under which this score was determined.

As an example, in assessing an individual's banking behavior, four factors may be considered: entity type (e.g. an account), activities (e.g. international wire transfer), timeframe (e.g. within the last 3 months), and transaction measurement (e.g. min, max, etc.). Each of these factors may be looked at in combinations in order to identify potential patterns of fraudulent activity, which quickly leads to a large set of combinations on which to perform analytics depending on the range of potential values for those factors and the granularity of the analytics to be performed. Consider, for example, an assessment where there are: six (6) entity types—customer, counterparties, customer-counterparty relationship, account, employee, and device: ten (10) types of activities—i.e. different payment types, each which may have at least one meaningful filter, such as international, domestic, currency, or the like; fifteen (15) timeframes—all time, year, quarter, month, week, day, hour, minute, or the like, plus common variants like last three days, last two days, last twelve hours, last four hours, last two hours, last thirty second, last 10 seconds, or the like; and ten (10) transaction measurements—maximum, minimum, standard deviation, or the like. Therefore, in this example, there would be a set of 6*10*15*10=30,000 indicators that need to be evaluated in different combinations. These four factors collectively define a profile and multiple profiles are analyzed as a group to determine the overall fraud risk assessment.

Thus, the mechanisms of the illustrative embodiments provide for dynamically evaluating fraud risk by deriving a variety of different risk indicators, profiles, and groups in order to provide the best overall risk assessment for use in identifying potential fraud cases all within a dynamically changing environment. Traditionally, most of the risk assessment is either a) rule based or b) based on defined peer groups. In the former, each rule uses certain risk indicators which all need to be predefined and can only be used to detect previously known potential fraud. In the latter, the peer groups must be predefined, again restricting the analysis to prior fraud patterns and both by looking at data combinations in predetermined ways. The mechanisms of the illustrative embodiments utilize the dynamic nature of the data to better identify potential fraud through the combined use of dynamic data profiling and analytic hierarchy processing.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

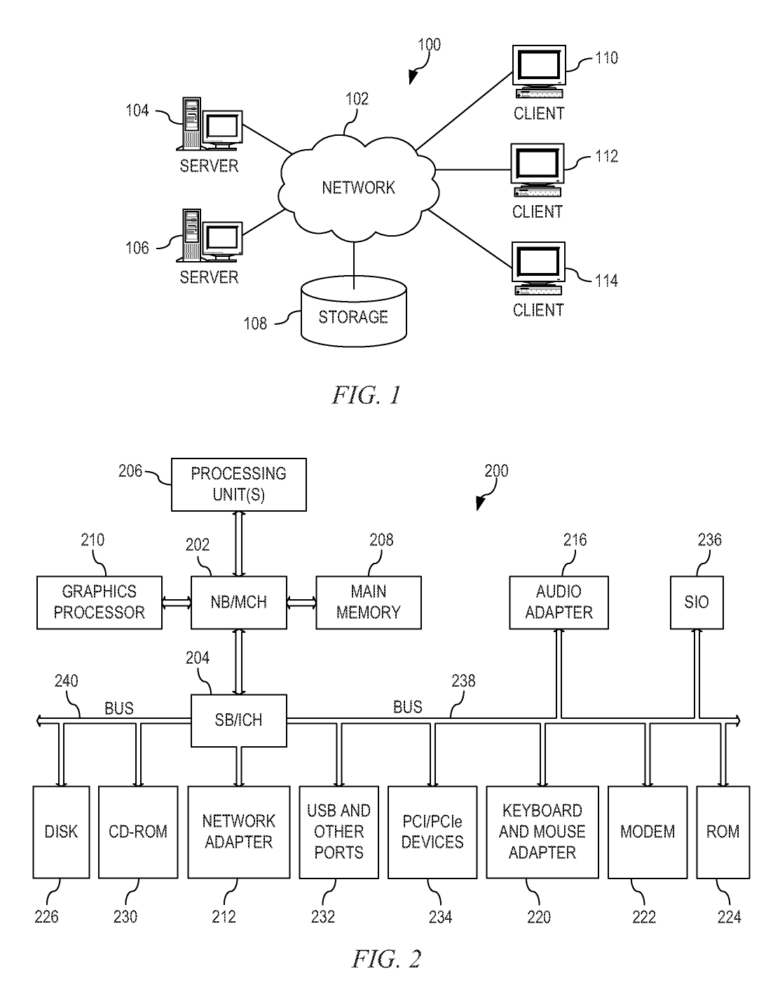

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104 may be specifically configured to implement a mechanism for dynamically evaluating fraud risk. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, and software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates dynamically evaluating fraud risk.

As noted above, the mechanisms of the illustrative embodiments utilize specifically configured computing devices, or data processing systems, to perform the operations for dynamically evaluating fraud risk. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external affects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System P® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to dynamically evaluating fraud risk.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

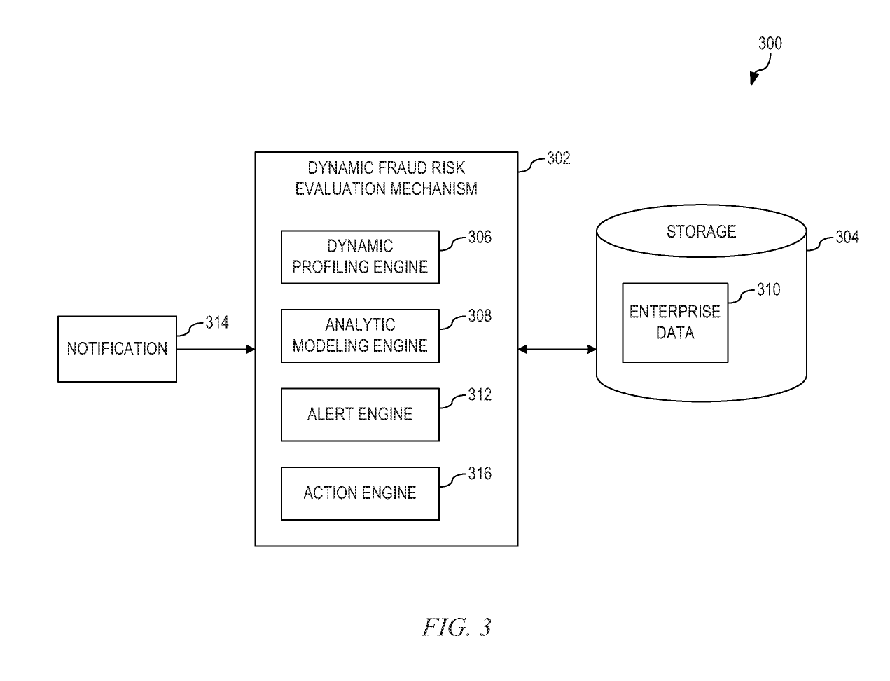

FIG. 3 depicts an exemplary functional block diagram of a data processing system in which a dynamic fraud risk evaluation mechanism operates in accordance with an illustrative embodiment. Data processing system 300 comprises dynamic fraud risk evaluation mechanism 302 coupled to storage 304. Dynamic fraud risk evaluation mechanism 302 comprises dynamic profiling engine 306 and analytic modeling engine 308. Dynamic fraud risk evaluation mechanism 302 executes an automated approach to rapidly and automatically generate a theoretically limitless set of profiles across attributes in which an object participates. As stated previously, a profile is a representation of combinations of statistical indicator values based on attributes between combinations of records within an enterprise such as, for example, a maximum, minimum, standard deviation, or the like, for a daily balance of an account, for the last month, last quarter, last year, or the like. The profiled objects may be any object (i.e. physical, virtual, or the like) that has been configured to exist within a domain data model.

As the process of dynamically evaluating fraud risk begins by dynamic fraud risk evaluation mechanism 302 may receive a notification 314, such as a transaction request, a time of day being met, an event occurring, or the like a device at a geographic location and at an identifiable time. Dynamic profiling engine 306 then identifies a set of profile indicators that are required for detection of fraud. As exemplified previously, one exemplary assessment may include: six (6) entity types—customer, counterparties, customer-counterparty relationship, account, employee, and device; ten (10) types of activities—i.e. different payment types, each which may have at least one meaningful filter, such as international, domestic, currency, or the like; fifteen (15) timeframes—all time, year, quarter, month, week, day, hour, minute, or the like, plus common variants like last three days, last two days, last twelve hours, last four hours, last two hours, last thirty second, last 10 seconds, or the like; and ten (10) transaction measurements—maximum, minimum, standard deviation, or the like. Therefore, in this example, there would be a set of 6*10*15*10=30,000 indicators that need to be evaluated in different combinations.

Dynamic profiling engine 306 then automatically analyzes a configuration and population of enterprise data 310 in storage 304 to identify a focal point within the enterprise's core business objects and associated attributes for use in comparison to the information associated with the notification in order to detect a fraudulent action. That is, utilizing temporal scope (i.e. time values associated with the identified objects) and distance (i.e. a number of hops between identified objects), dynamic profiling engine 306 performs statistical object profiling through pattern modeling, such as anomaly modeling, duplicate modeling, or the like, to generate second order sets of indicators or peer groups of objects as well as identify key object profile statistics. Therefore, dynamic profiling engine 306 manages the actual creation of the objects, peer groups of objects, and object profile statistics, and, in addition, uses the individual objects, peer groups, and object profile statistics to generate deterministic rules and predefined models for fraud detection.

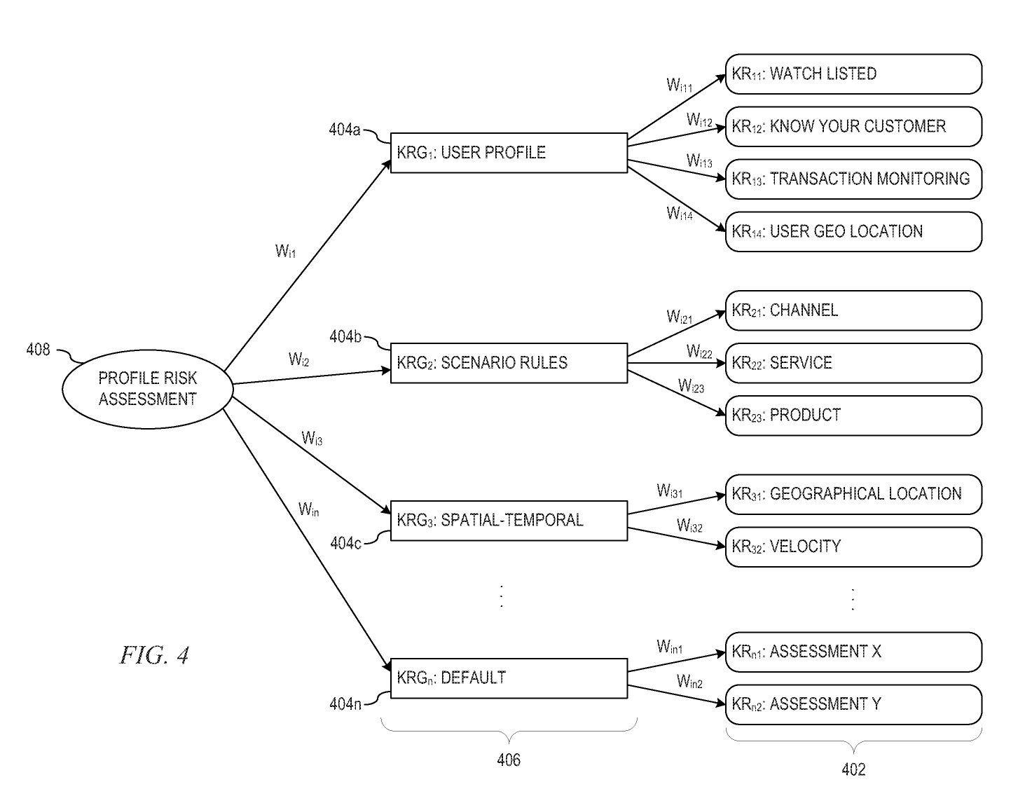

FIG. 4 depicts one example of an aggregation of profile elements when assessed by the dynamic fraud risk evaluation mechanism 302 of FIG. 3 in accordance within an illustrative embodiment. That is, the analysis of the enterprise data 310 performed by dynamic profiling engine 306 results in a list of key risk indicators (KRI) 402. The statistical object profiling performed by dynamic profiling engine 306 using utilizing temporal scope and distance results in peer groups of objects 404a-404n as well as key object profile statistics, which may be used, in one embodiment, to determine weights Wᵢ₁ₙ-Wᵢₘₙ that may be used to weight each of the identified indicators, although predetermined weights may also be utilized in another embodiment. Thus, dynamic profiling engine 306 may employ supervised artificial intelligence (AI), such as a machine learning algorithm, to adjust the weighted aspects and determine groupings for the fraud determinations.

Again, the individual objects that are grouped into the peer groups identify specific use case scenarios or indicator combinations that are assessed for some degree of possible fraud. Returning to FIG. 3, analytic modeling engine 308 then rolls up the weighted scores by categorized peer groupings of the second order profile indicators, which generates a third order profile of categorized grouping of key risks (KRG). That is, analytic modeling engine 308 sums the weighted scores of each of the key risk indicators in the respective peer groups to generate a classification or categorization of the peer group that the peer group is specifically modeling, which is represented in the example of FIG. 4 by list of categorized grouping 406. This categorized grouping may represent different types of risk, such as user profile risk, transactional risks, geographic risk, temporal risk, account risk, relationship risk, or the like.

With the categorized grouping of risks (KRG), analytic modeling engine 308 performs an additive summary for the combined risks. That is, analytic modeling engine 308 may determine profile risk assessment, such as profile risk assessment 408 of FIG. 4, or risk score of a combination from the categorized groupings of risks (KRG) using the following function:

Risk(i)=f(KRG₁,KRG₂,KRG₃, . . . ,KRGₙ).

Further, analytic modeling engine 308 may weight each KRG using a different predetermined weight, especially since key risk indicators (KRI) may be used in different manners such that analytic modeling engine 308 determines a risk score of a combination from the categorized groupings of risks (KRG) using the following weighted function:

Weighted Risk(i)=f(Wᵢ₁*KRG₁,Wᵢ₂*KRG₂,Wᵢ₃*KRG₃, . . . ,Wᵢₙ*KRGₙ,

where Wᵢⱼ represents the contribution of KRGᵢⱼ to the total risk score. That is the weighted contribution provides additional adjustments based on the context of that assessment. For instance, the geography that a user's profile indicates may a different weight than the geography from which a large transaction occurs. Both contribute to the risk, but at different weights.

Finally, analytic modeling engine 308 utilizes a set of thresholds to determine an overall rating of the risk score. For example, if the determined risk score (either weighted or unweighted) is below a first threshold, then the overall risk score would be considered low. If the overall risk score is identified as low, then alert engine 312 may either issue a warning or not issue anything at all and action engine 316 may permit the action to continue. If the determined risk score (either weighted or unweighted) is equal to or above the first threshold but below a second threshold, then the overall risk score would be considered medium. If the overall risk score is identified as medium, then alert engine 312 may issue a warning and action engine 316 requests additional authentication from the requestor before the transaction is permitted. If the determined risk score (either weighted or unweighted) is at or above the second threshold, then the overall risk score would be considered high. If the overall risk score is identified as high, then alert engine 312 issues a warning and action engine 316 request human intervention for the transaction request, such as from a human authenticator.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

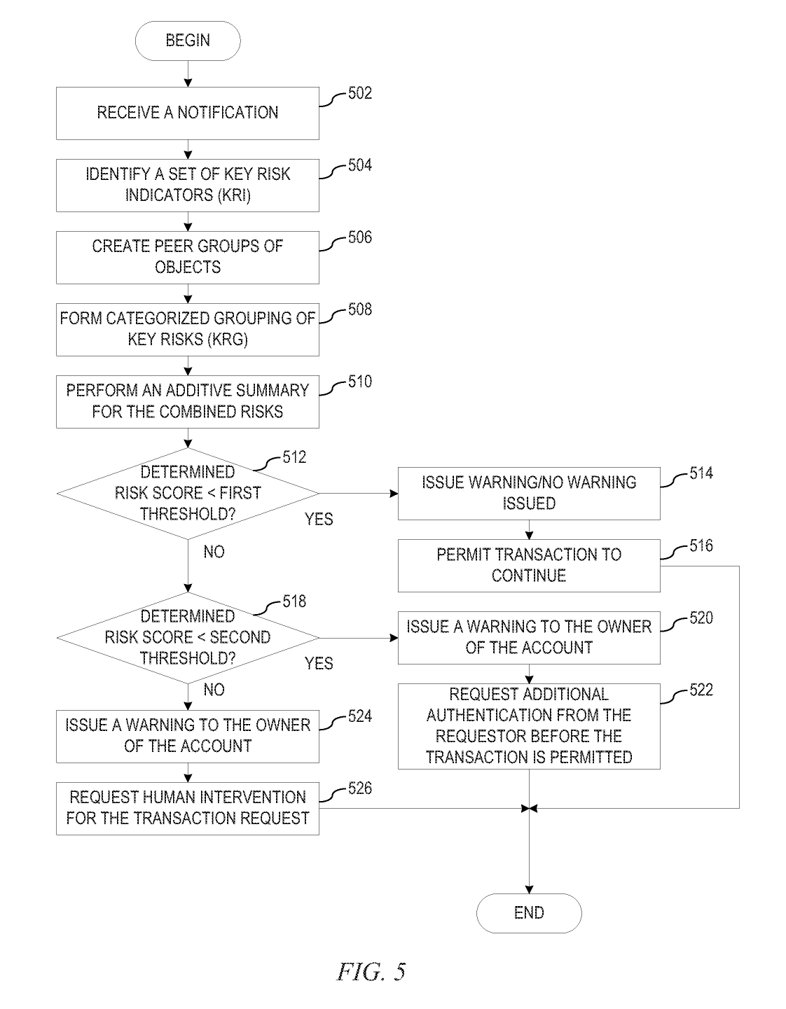

FIG. 5 depicts an exemplary flow diagram of the operation performed by a dynamic fraud risk evaluation mechanism in accordance with an illustrative embodiment. As the operation begins, the dynamic fraud risk evaluation mechanism receives a notification (step 502). The dynamic fraud risk evaluation mechanism identifies a set of key risk indicators (KRI) that are required for detection of fraud (step 504). The dynamic fraud risk evaluation mechanism then analyzes a configuration and population associated with a focal object of enterprise data to identify the enterprise's core business objects and associated attributes in order to create second order sets of key risk indicators (KRI) or peer groups of objects (step 506). That is, utilizing temporal scope (i.e. time values associated with the identified objects) and distance (i.e. a number of hops between identified objects), the dynamic fraud risk evaluation mechanism performs statistical object profiling through pattern modeling, such as anomaly modeling, duplicate modeling, or the like, to generate second order sets of key risk indicators or peer groups of objects as well as identify key object profile statistics. Therefore, the dynamic fraud risk evaluation mechanism manages the actual creation of the objects, peer groups of objects, and object profile statistics, and, in addition, uses the individual objects, peer groups, and object profile statistics to generate deterministic rules and predefined models for fraud detection, which may be uses, in one embodiment, to determine weights Wᵢ₁ₙ-Wᵢₘₙ that may be used to weight each of the identified indicators, although predetermined weights may also be utilized in another embodiment. Thus, the dynamic fraud risk evaluation mechanism may employ supervised artificial intelligence (AI), such as a machine learning algorithm, to adjust the weighted aspects and determine groupings for the fraud determinations.

The dynamic fraud risk evaluation mechanism then rolls up the weighted scores by categorized peer groupings of the second order profile indicators to form a third order profile of categorized grouping of key risks (KRG) (step 508). That is, the dynamic fraud risk evaluation mechanism sums the weighted scores of each of the key risk indicators in the respective peer groups to generate a classification or categorization of the peer group that the peer group is specifically modeling. This categorized grouping may represent different types of risk, such as user profile risk, transactional risks, geographic risk, temporal risk, account risk, relationship risk, or the like.

With the categorized grouping of risks (KRG), the dynamic fraud risk evaluation mechanism performs an additive summary for the combined risks (step 510). That is, the dynamic fraud risk evaluation mechanism may determine a risk score of a combination from the categorized groupings of risks (KRG) using the following function:

Risk(i)=f(KRG₁,KRG₂,KRG₃, . . . ,KRGₙ).

Further, the dynamic fraud risk evaluation mechanism may weight each KRG using a different predetermined weight, especially since key risk indicators (KRI) may be used in different manners such that the dynamic fraud risk evaluation mechanism determines a risk score of a combination from the categorized groupings of risks (KRG) using the following weighted function:

Weighted Risk(i)=f(Wᵢ₁*KRG₁,W₁₂*KRG₂,Wᵢ₃*KRG₃, . . . ,Wᵢₙ*KRGₙ,

where Wᵢⱼ represents the contribution of KRGᵢⱼ to the total risk score. That is the weighted contribution provides additional adjustments based on the context of that assessment. For instance, the geography that a user's profile indicates may a different weight than the geography from which the transaction. Both contribute to the risk, but at different weights.

The dynamic fraud risk evaluation mechanism then determines whether the determined risk score (either weighted or unweighted) is below a first threshold (step 512). If at step 512 the dynamic fraud risk evaluation mechanism determines that the determined risk score (either weighted or unweighted) is below the first threshold, then the dynamic fraud risk evaluation mechanism issue a warning or not issue anything at all (step 514) and permit transaction to continue (step 516), with the operation terminating thereafter. If at step 512 the dynamic fraud risk evaluation mechanism determines that the determined risk score (either weighted or unweighted) is at or above the first threshold, the dynamic fraud risk evaluation mechanism determines whether the determined risk score (either weighted or unweighted) is below a second threshold (step 518). If at step 518 the dynamic fraud risk evaluation mechanism determines that the determined risk score (either weighted or unweighted) is below the second threshold, then the dynamic fraud risk evaluation mechanism issues a warning (step 520) and requests additional authentication from the requestor before the transaction is permitted (step 522), with the operation terminating thereafter. If at step 518 the dynamic fraud risk evaluation mechanism determines that the determined risk score (either weighted or unweighted) is at or above the second threshold, the dynamic fraud risk evaluation mechanism 312 issues a warning (step 524) and requests human intervention for the transaction request (step 526), with the operation terminating thereafter. The identified overall risk score is then used to counteract the determined fraud.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for dynamically evaluating fraud risk. The mechanisms utilize analytical approaches to dynamically construct a hierarchical structure that can be used for risk assessment. The mechanisms generate a list of all related low-level risk indicators and apply analytical approaches to cluster these indicators into representative groups. The mechanisms provide for adjusting an importance of the indicators and grouping based on specific domain and past experience in order to determine an overall risk of any determined fraud.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for dynamically evaluating fraud risk, the method comprising:
responsive to receiving a notification, automatically analyzing a set of indicators associated with a focal object to form a combined assessment;
comparing the combined assessment to a set of pattern fraud determinations;
adjusting the combined assessment based on the set of pattern fraud determinations to dynamically determine a current fraud assessment of the focal object; and
performing an action based on the current fraud assessment.

2. The method of claim 1, where the current fraud assessment is based on a set of key risk indicators grouped into key risk groups and wherein the current fraud assessment is determined based on a function of the values from each of the key risk groups.

3. The method of claim 1, where the current fraud assessment is based on a set of key risk indicators grouped into key risk groups and wherein the current fraud assessment is determined based on a weighted function of the values from each of the key risk groups.

4. The method of claim 1, wherein the action is permitting the transaction when the current fraud assessment is below a first threshold.

5. The method of claim 1, wherein the action is requesting an additional authentication from the requestor when the current fraud assessment is at or above a first threshold and below a second threshold.

6. The method of claim 1, wherein the action is requesting an intervention for the transaction request when the current fraud assessment is above a second threshold.

7. The method of claim 1, further comprising:
utilizing a supervised artificial intelligence (AI) algorithm to adjust weighted aspects and determine groupings for the fraud determinations.

8. A computer program product comprising a computer readable storage medium having a computer readable program stored therein, wherein the computer readable program, when executed on a computing device, causes the computing device to:
responsive to receiving a notification, automatically analyze a set of indicators associated with a focal object to form a combined assessment;
compare the combined assessment to a set of pattern fraud determinations;
adjust the combined assessment based on the set of pattern fraud determinations to dynamically determine a current fraud assessment of the focal object; and
perform an action based on the current fraud assessment.

9. The computer program product of claim 8, where the current fraud assessment is based on a set of key risk indicators grouped into key risk groups and wherein the current fraud assessment is determined based on a function of the values from each of the key risk groups.

10. The computer program product of claim 8, where the current fraud assessment is based on a set of key risk indicators grouped into key risk groups and wherein the current fraud assessment is determined based on a weighted function of the values from each of the key risk groups.

11. The computer program product of claim 8, wherein the action is permitting the transaction when the current fraud assessment is below a first threshold.

12. The computer program product of claim 8, wherein the action is requesting an additional authentication from the requestor when the current fraud assessment is at or above a first threshold and below a second threshold.

13. The computer program product of claim 8, wherein the action is requesting an intervention for the transaction request when the current fraud assessment is above a second threshold.

14. The computer program product of claim 8, wherein the computer readable program further causes the computing device to:
utilize a supervised artificial intelligence (AI) algorithm to adjust weighted aspects and determine groupings for the fraud determinations.

15. An apparatus comprising:
a processor; and
a memory coupled to the processor, wherein the memory comprises instructions which, when executed by the processor, cause the processor to:
responsive to receiving a notification, automatically analyze a set of indicators associated with a focal object to form a combined assessment;
compare the combined assessment to a set of pattern fraud determinations;
adjust the combined assessment based on the set of pattern fraud determinations to dynamically determine a current fraud assessment of the focal object; and
perform an action based on the current fraud assessment.

16. The apparatus of claim 15, where the current fraud assessment is based on a set of key risk indicators grouped into key risk groups and wherein the current fraud assessment is determined based on a function of the values from each of the key risk groups.

17. The apparatus of claim 15, where the current fraud assessment is based on a set of key risk indicators grouped into key risk groups and wherein the current fraud assessment is determined based on a weighted function of the values from each of the key risk groups.

18. The apparatus of claim 15, wherein the action is permitting the transaction when the current fraud assessment is below a first threshold.

19. The apparatus of claim 15, wherein the action is requesting an additional authentication from the requestor when the current fraud assessment is at or above a first threshold and below a second threshold.

20. The apparatus of claim 15, wherein the action is requesting an intervention for the transaction request when the current fraud assessment is above a second threshold.
